(19) United States
(12) Patent Application Publication
(10) Pub. No.: US 2013/0311907 A1
(43) Pub. Date: Nov. 21, 2013

(54) SOCIAL NETWORKING PLATFORM

(71) Applicant: TAWKERS, INC., New York, NY (US)

(72) Inventors: BLAKE IAN GOLDSMITH, New York, NY (US); JORDAN SUDY, New York, NY (US); RODRIGO BARTELS GONZALEZ, Heredia (CR)

(73) Assignee: TAWKERS, INC., New York, NY (US)

(21) Appl. No.: 13/896,997

(22) Filed: May 17, 2013

Related U.S. Application Data
(60) Provisional application No. 61/648,785, filed on May 18, 2012.

(51) Int. Cl. H04L 12/58

(52) U.S. Cl. CPC H04L 51/32
USPC 715/758

(57) ABSTRACT

Various exemplary embodiments relate to a social networking platform. The social networking platform may provide hosted events where audience members can comment on the events. A rating system may select comments that are positively rated for display to all audience members. Audience members may have a Volume rating that affects whether their comments are seen. Hosts may spotlight comments, enabling all audience members to view the comment and also increasing the rating of the user posting the comment.

This application claims the benefit of U.S. Provisional Application No. 61/648,785, filed on May 18, 2012, the entire disclosure of which is incorporated herein by reference.

### TECHNICAL FIELD

Various exemplary embodiments disclosed herein relate generally to online communication.

### BACKGROUND

Computer networks such as the Internet provide high speed mass communication. Social networking uses the Internet to communicate among various groups. Online communication through social networks is frequently unorganized and chaotic, preventing the medium from fulfilling its potential. Accordingly, there is need for a new social networking platform.

### SUMMARY

Various exemplary embodiments relate to a social networking platform that may house live conversations in text format and streams them publicly to a digital audience. The platform may combine existing broadcast media formats and social networking platforms, creating a true Social Media experience across web and mobile devices. This is a new and interactive form of broadcast media.

The platform may interact with other social networking platforms. The platform may provide a clean, simple, swipeable interface including at least two panels: an upper panel for hosts, and a lower panel for the audience. This two panel display may allow users to observe a public text chat between two host influencers (experts, celebrities, critics, leaders, etc.) in the upper panel, while also discussing and commenting on it in the social forum that lives in the lower audience panel.

The top panel may be fixed and serves as the online venue for the main digital event. The lower panel may be swipeable between a public forum, a live browser, a user profile page, an audience view of all profiles of all users in the audience, and panels showing other information related to the platform.

At any given time users may view the total number of event participants, vote up or vote down their comments, listen to audience members if intrigued by their remarks, or mute audience members if their input is not of interest. The comments that receive the most votes may be displayed in the public forum, visible to all users currently viewing that panel. In addition, each user may have a Volume, a score based on merits earned previously in the platform. A high volume may help push a user's comment to the forum. An event's host may have the ability to spotlight user comments that they find compelling, which may lift that comment into the upper host panel. If a user is spotlighted by a high profile host into one of the featured events, that user may be instantly provided with an enormous audience of potentially ongoing listeners.

The platform may catalogue dialogue. Any conversations that take place on the platform may be permanently searchable and citable through the platform. Quotes may be provided within the context of the conversation. True thought pioneers may be pinpointed by their comments. Conversely, flubs and faux pas may also be archived.

### BRIEF DESCRIPTION OF THE DRAWINGS

In order to better understand various exemplary embodiments, reference is made to the accompanying drawings, wherein:

FIG. 1 illustrates an exemplary user interface for presenting a social networking platform;

FIG. 1A illustrates another exemplary user interface for presenting a social networking platform;

FIG. 2 illustrates another exemplary user interface for presenting a browser within a social networking platform;

FIG. 3 illustrates another exemplary user interface for presenting audience information within a social networking platform;

FIG. 4 illustrates another exemplary user interface for presenting notifications within a social networking platform;

FIG. 5 illustrates a user interface for generating a new event;

FIG. 6 illustrates an exemplary user interface for navigating between a plurality of events;

FIG. 7 illustrates another exemplary user interface for presenting statistics within a social networking platform;

FIG. 8 illustrates a flowchart showing various stages of an audience comment; and

FIG. 9 illustrates an exemplary network for implementing a social networking platform.

### DETAILED DESCRIPTION

Referring now to the drawings, in which like numerals refer to like components or steps, there are disclosed broad aspects of various exemplary embodiments.

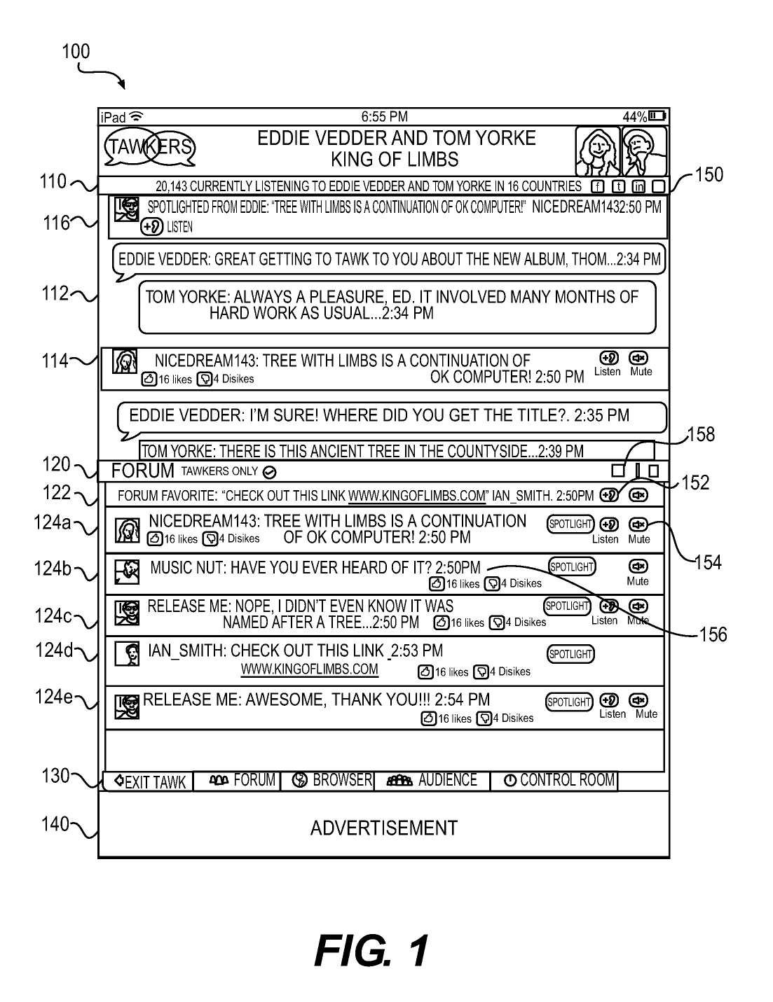

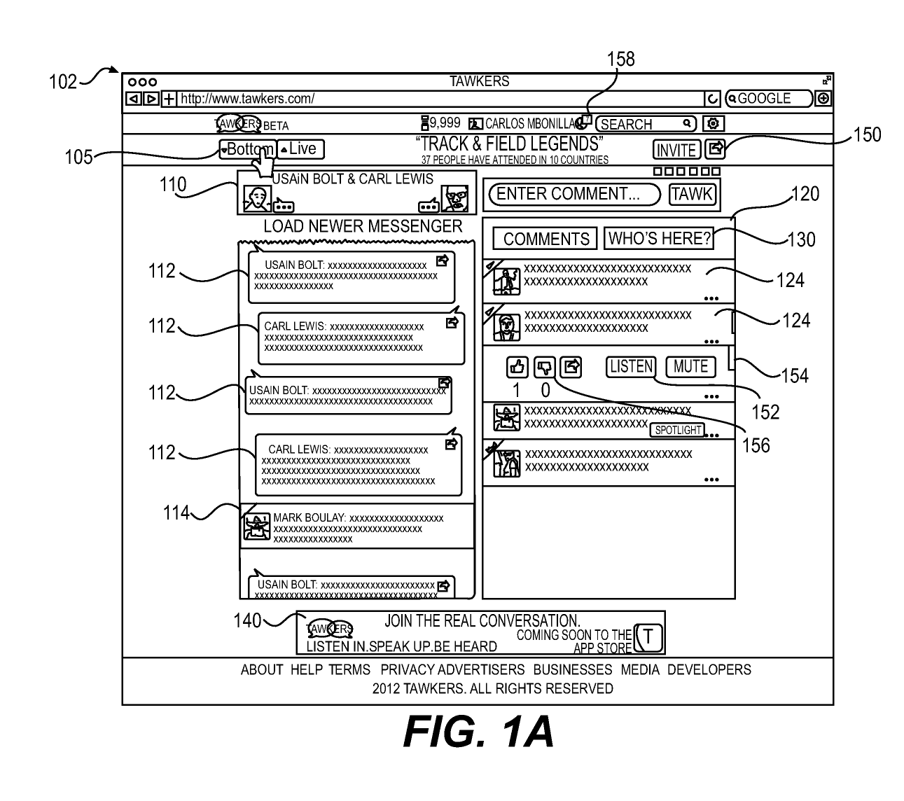

FIG. 1 illustrates an exemplary user interface 100 for presenting a social networking platform. The exemplary user interface 100 may include a host panel 110, lower panel 120, selection panel 130, content panel 140. Exemplary user interface 100 may also include various interaction buttons including: sharing buttons 150, listen button 152, mute button 154, rating buttons 156, and notifications button 158.

Host panel 110 may present content from two or more event hosts and information about the event. For example, host panel 110 may indicate the names of the host, a name of the event, an audience size, and an audience location. Host panel 110 may also include host comments 112, spotlighted comment 114, and most recently spotlighted comment 116. The host panel 110 may have a prominent location within the user interface. For example, host panel 110 may be located on the top half of the interface 100. The host panel may be under the control of the hosts, allowing the online event to focus on the content provided by the hosts.

Host comments 112 may be comments made by event hosts as part of the event. The host comments 112 may be visible to any audience member for the event. Host comments 112 may indicate the host who made the comment. Host comments 112 may be presented in the order made by the hosts and include a timestamp indicating when the comment was made.

Spotlighted comment 114 may be a comment made by an audience member that has been selected by an event host. For example, spotlighted comment 114 may correspond to forum comment 124a. When an event host selects a comment, the selected comment may appear in host panel 110. Spotlighted comment 114 may indicate the name of the audience member who made the comment as well as a timestamp the comment was made and the name of the host who selected the comment. Spotlighted comment 114 may also include interaction buttons, which will be discussed in further detail below.

Most recent spotlighted comment 116 may indicate a comment that has most recently been selected by a host. For example, most recent spotlighted comment 115 may correspond to spotlighted comment 114. Most recent spotlighted comment 116 may be located at a fixed location within host panel 110 such as, for example, the top. Most recent spotlighted comment 116 may remain visible even if spotlighted comment 114 is no longer displayed because, for example, host panel 110 has scrolled.

Lower panel 120 may be a forum panel, which may present content from audience members for an event. Forum panel 120 may include forum favorite 122 and audience comments 124. Forum panel 120 may be audience-moderated. That is, the comments displayed in forum panel 120 may be selected based on feedback from audience members. The comments may be displayed at a rate allowing audience members to read each comment. A method of audience moderating for the forum panel 120 will be discussed in further detail below.

Forum favorite 122 may indicate an audience comment that has received the highest rating from members of the audience. For example, forum favorite 122 may correspond to audience comment 124d. The selection of the forum favorite 122 may be based on the number of audience members who have positively rated the comment. Other factors such as negative ratings by audience members and a rating of the commenting audience member may also be considered.

Audience comments 124 may indicate comments made by audience members. For example, exemplary forum panel 120 displays audience comments 124a-e. Each audience comment 124 may be selected according to an audience moderation method. Audience comments 124 may also be presented based on selections made the user viewing user interface 100. For example, a user may indicate that the user always wants to view comments made by selected audience members or a user may indicate that the user never wants to view comments made by selected audience members.

Selection panel 130 may present various options for content to be located in the lower panel 120. Selection panel 130 may allow a user to select different content for lower panel 120 by selecting a button. Alternatively, second panel 130 may be swipable, allowing a user to change content by moving a finger or other indicator across lower panel 120. Selection panel 130 may indicate a lower panel 120 selected by swiping. Exemplary content panels that may be located in lower panel 120 include: a forum panel, a browser panel, an audience panel, and a control room panel. Selection panel 130 may also include an option for leaving the event.

Content panel 140 may provide a location for displaying additional content such as, for example, advertising. Content for content panel 140 may be provided by a service provider that hosts an event.

Sharing buttons 150 may be interaction buttons allowing a user to share information related to the event. Selecting of a sharing button 150 may generate a communication via an external communications channel or application.

Listen button 152 may be an interaction button allowing a user to view all comments made by a selected user. Listen button 152 may be associated with an audience comment. Selecting listen button 152 may add the audience member who posted the comment to a list of audience members whose comments are always displayed.

Mute button 154 may be an interaction button allowing a user to block all comments made by a selected user. Mute button 154 may be associated with an audience comment. Selecting mute button 154 may add the audience member who posted the comment to a list of audience members whose comments are never displayed.

Rating buttons 156 may allow a user to rate a comment made by another audience member. Rating buttons 156 may provide a first button for positively rating the comment and a second button for negatively rating the comment. Ratings provided by users selecting rating buttons 156 may affect a rating of the individual comment and the rating of the audience member. The rating of the individual comment and the rating of the audience member may, in turn, but used to determine whether audience comments 124 are displayed in forum panel 120.

Notifications button 158 may allow a user to view various notifications. Notifications button 158 may indicate a number of notifications available for viewing. As shown in FIG. 1, the notification button 158 may be located at the top of forum panel 120. In various alternative embodiments, the notifications button 158 may be located on selection panel 130.

FIG. 1A illustrates another exemplary user interface 102 for presenting a social networking platform. User interface 102 may be similar to user interface 100, but may be formatted for display as a web application within a browser. User interface 102 may use a side-by-side arrangement of host panel 110 and audience forum panel 120. User interface 102 may include control buttons 105 for moving between desired portions of the event in the host panel 110. Various buttons on user interface 100 may be presented as menus. For example, notifications button 158 and sharing buttons 150 may be presented as a drop down list. Buttons related to individual audience member comments 124 may be hidden behind the comment itself. For example, clicking the comment 124 may reveal rating buttons 156, listen button 152, or mute button 154.

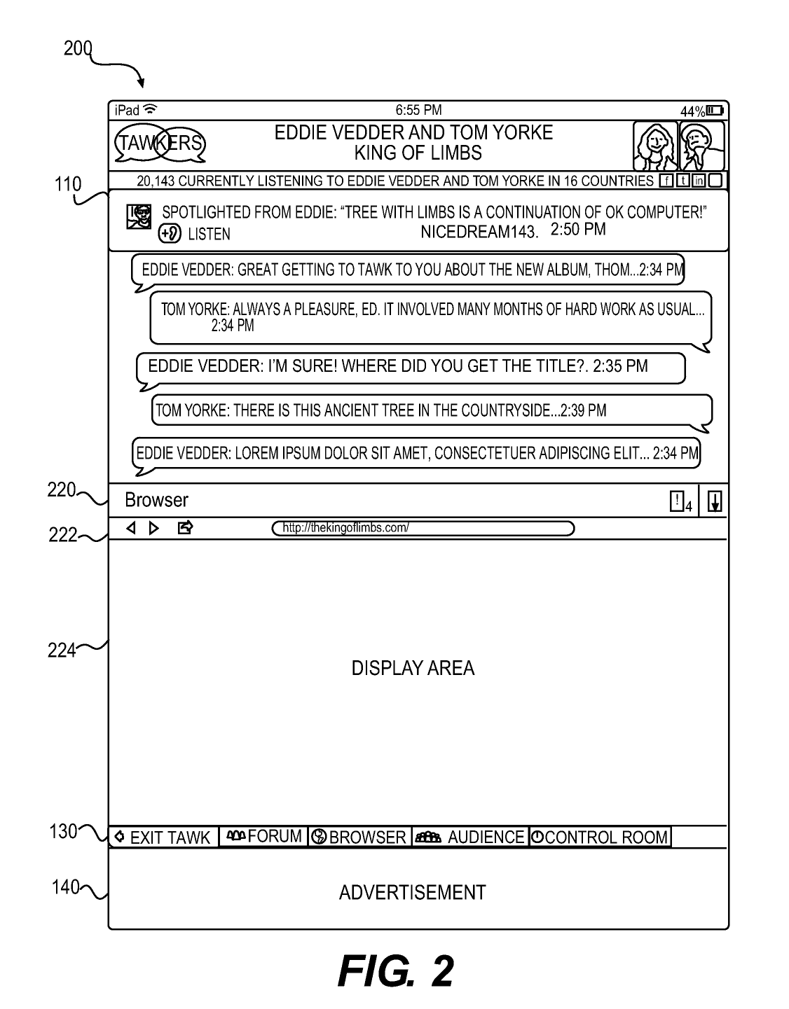

FIG. 2 illustrates another exemplary user interface 200 for presenting a browser within a social networking platform. User interface 200 may be similar to user interface 100. User interface 200 may be presented when a user selects a different lower panel 220. User interface 200 may include host panel 110, selection panel 130, and content panel 140, all of which may be similar to the corresponding panels described above regarding FIG. 1. User interface 200 may also include browser panel 220. A user may use browser panel 220 to view content related to an event without leaving the event. In particular, a user may be able to view content mentioned in a host comment 112 or an audience comment 124.

Browser panel 220 may present a browser for viewing content such as, for example, web pages and other documents. Browser panel 220 may include navigation options 222 and display area 224. Navigation options 222 may allow a user to select content to be viewed in display area 224. Display area 224 may display content selected by a user. Display area 224 may also allow a user to select content through known methods such as hyperlinks.

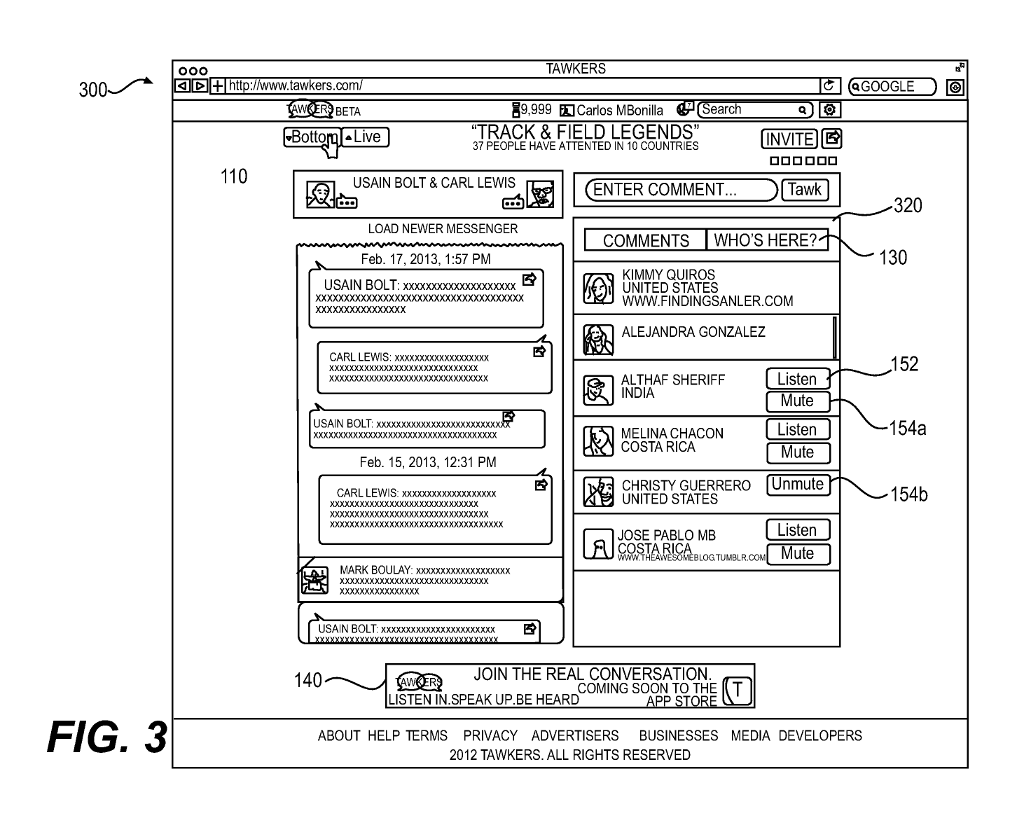

FIG. 3 illustrates another exemplary user interface 300 for presenting audience information within a social networking platform. User interface 300 may be similar to user interface 102. User interface 300 may be presented when a user selects a different audience panel 320. User interface 300 may include host panel 110, selection panel 130, and content panel 140, all of which may be similar to the corresponding panels described above regarding FIG. 1. User interface 300 may also include audience panel 320. A user may use audience panel 320 to view information regarding audience members of an event without leaving the event. In particular, a user may be able to view a complete list of audience members for the event. Audience panel 320 may be useful for locating audience members whose comments do not appear in forum panel 120, for example, muted audience members and low rated audience members.

Audience panel 320 may present a list of audience members viewing the event. Audience panel 320 may include one or more audience profiles 322. Audience profiles 322 may provide information regarding the audience member such as, for example, a picture, name, and location. Audience profiles 322 may be selectable and provide additional information when selected. Audience profiles 322 may also include a listen button 152 and a mute button 154. Listen button 152 and mute button 154 may be similar to like numbered buttons described above. Additionally, mute button 154 may indicate a status of the audience member. For example, mute button 154a may indicate that the audience member is not muted and mute button 154b may indicate that the audience member is muted and allow the user to unmute the audience member.

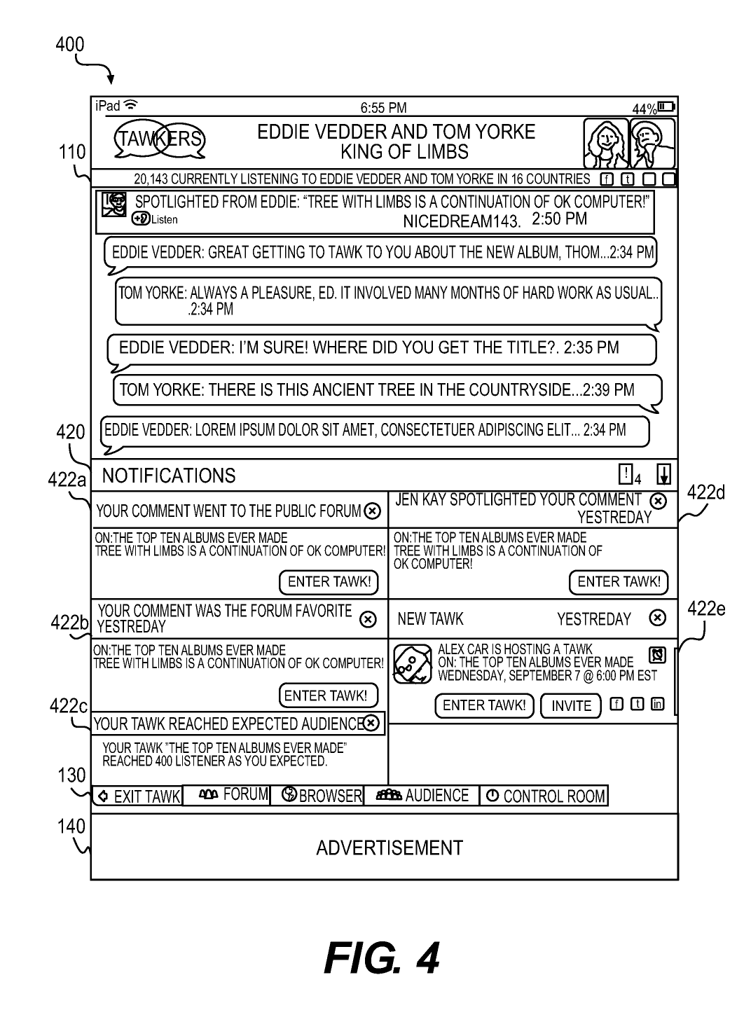

FIG. 4 illustrates another exemplary user interface 400 for presenting notifications within a social networking platform. User interface 400 may be similar to user interface 100. User interface 400 may be presented when a user selects notifications button 158. User interface 400 may include host panel 110, selection panel 130, and content panel 140, all of which may be similar to the corresponding panels described above regarding FIG. 1. User interface 400 may also include notifications panel 420. A user may use notifications panel 420 to view various notifications 422 provided by the social networking platform.

Notification 422a may indicate that a comment posted by the user has become viewable on the forum panel 120 for the event. Notification 422a may provide information about the comment including the event and content of the comment. Notification 422a may also provide a button enabling the user to enter the event where the comment is viewable.

Notification 422b may indicate that a comment posted by the user has become a forum favorite 122 for the event. Notification 422b may provide information about the comment including the event and content of the comment. Notification 422b may also provide a button enabling the user to enter the event where the comment is viewable.

Notification 422c may indicate that an event created by the user has obtained a certain status. For example, notification 422c may indicate that the event has reached a certain audience size. The user may be able to set a threshold measurement for an event and receive a notification when the event reaches the threshold measurement. Notification 422c may also provide a button enabling the user to enter the event.

Notification 422d may indicate that a comment posted by the user has been spotlighted by a host of the event. Notification 422d may provide information about the comment including the event, content of the comment, and name of the host who spotlighted the comment. Notification 422d may also provide a button enabling the user to enter the event where the comment is viewable.

Notification 422e may indicate that a new event has become available. Notification 422e may provide information regarding the event such as the name of the event and the name of the hosts of the event. Notification 422e may also provide a button to enter the event and sharing buttons 150 for communicating information regarding the event. Notification 422e may also be used to receive information regarding a particular host. For example, a user may opt to receive a notification whenever a certain host enters an event or creates a new event.

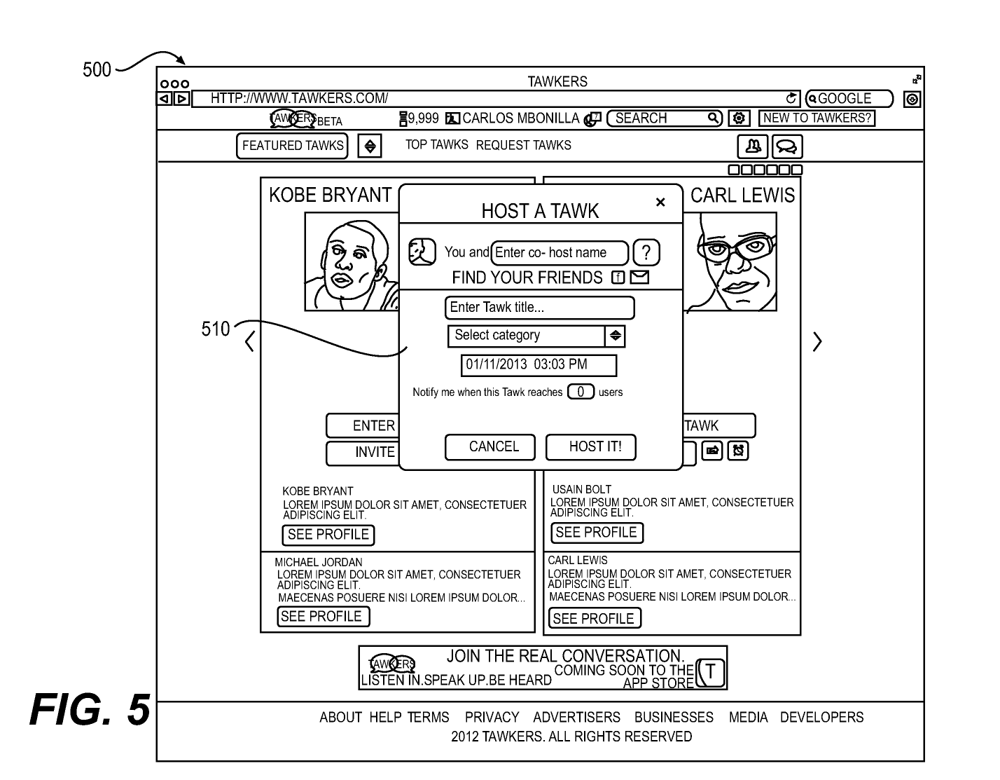

FIG. 5 illustrates a user interface 500 for generating a new event. User interface 500 may include box 510 for entering information regarding the event. Box 510 may include fields for various information for the event. For example, box 510 may include fields for: a title, a category, a date, a start time, a host biography, co-host names, and a notification threshold. Any user may use user interface 500 for creating a new event. When a user creates an event, the user may become a host of the event. Other users indicated in the co-host names field may also be hosts of the event. Events created using user interface 500 may be viewed by other users as audience members.

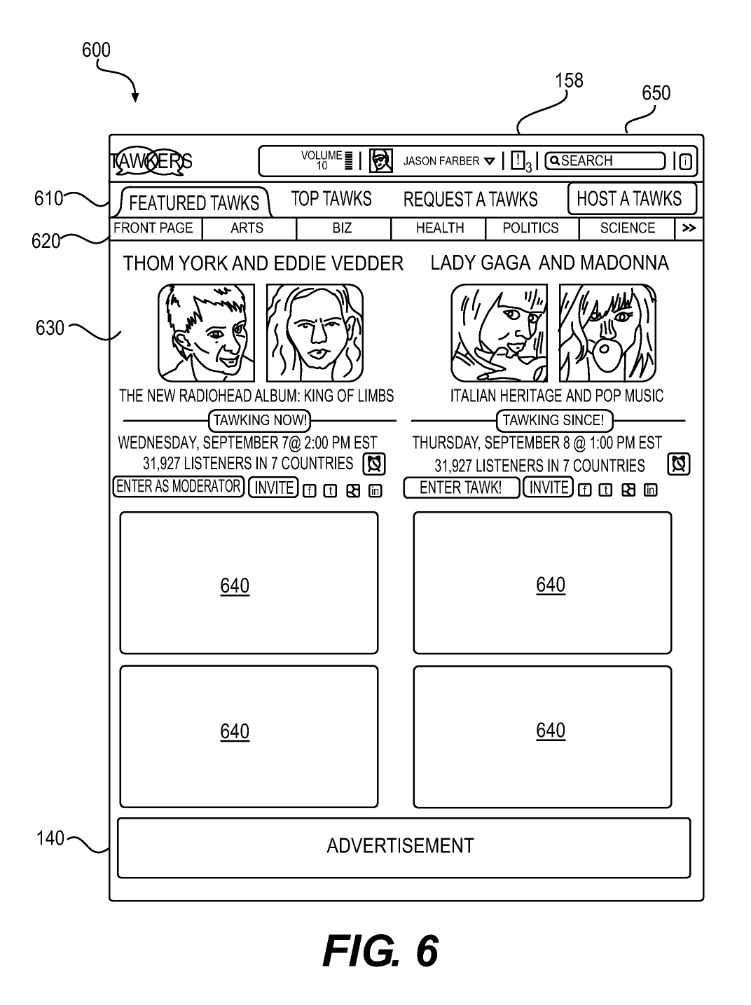

FIG. 6 illustrates an exemplary user interface 600 for navigating between a plurality of events. User interface 600 may include tabs 610, categories 620, event information 630, host profiles 640, and search box 650. User interface may also include a content panel 140 and notification button 158, described above with reference to FIG. 1.

Tabs 610 may provide a user with options for displaying information related to events. For example, tabs 610 may provide a featured events tab, a top events tab, and a request an event tab. The featured events tab may display events that have been selected by a service provider. The top events tab may display events that have the highest number of audience members. The request an event tab may provide a user an opportunity to request an event between certain hosts. A list of requested events may be displayed showing the most popular requested events.

Categories 620 may provide options for a user to select events based on the topic of the event. Selecting one of the categories 620 may provide event information 630 for events related to that category.

Event information 630 may provide information about an individual event. Event information 630 may include: the names of the hosts, the topic for the event, the current status of the event, the start time of the event, the number of audience members, and biographical information about the hosts. The event information 630 may also include buttons for entering the event as an audience member and buttons for sharing the event.

Host profiles 640 may include information regarding each host participating in the event. The host profile may include information available in audience member profile 322 and any additional information entered by the host for the particular event.

Search box 650 may allow a user to search for events. A user may enter keywords in search box 650 and be provided with a list of events related to the keywords.

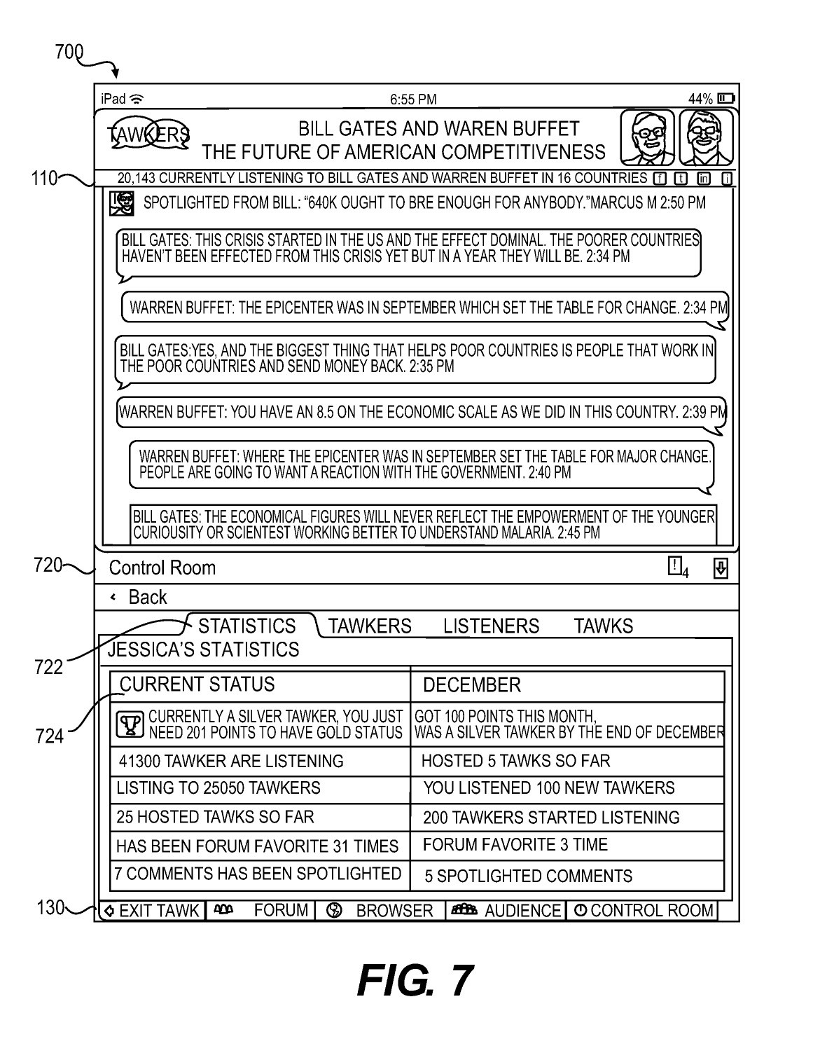

FIG. 7 illustrates another exemplary user interface 700 for presenting statistics within a social networking platform. User interface 700 may be similar to user interface 100. User interface 700 may be presented when a user selects a different lower panel 720. User interface 700 may include host panel 110, selection panel 130, and content panel 140, all of which may be similar to the corresponding panels described above regarding FIG. 1. User interface 700 may also include control room panel 720. A user may use control room panel 720 to view statistics regarding the user. In particular, a user may be able to view statistics contributing to the user's Volume as described below. Control room panel 720 may include tabs 722, and information area 724. Tabs 722 may allow options to view information regarding user statistics, selected users to listen to, users who are listening, and events. When a statistics tab is selected, the user may view information regarding the user's activity within the social networking platform. When a selected users tab is selected, information area 724 may present information regarding selected users who the user is listening to. When the listeners tab is selected, information area 724 may display information regarding other users who have chosen to listen to the current user. When the events tab is selected, the information area 724 may display information regarding past, current, and future events the current user has selected.

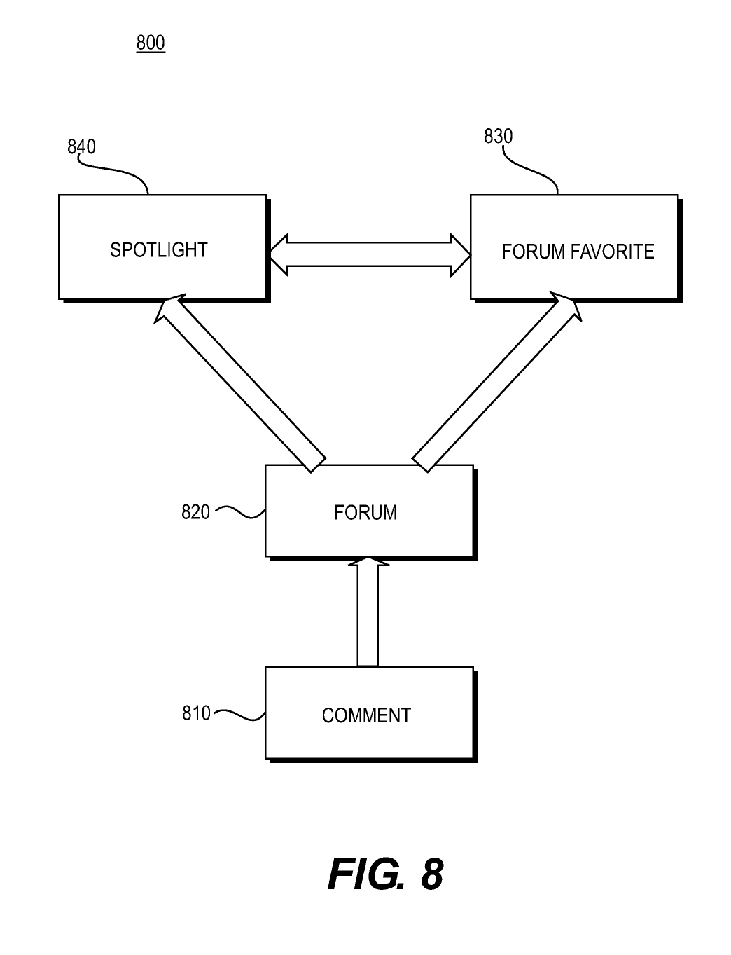

FIG. 8 illustrates a flowchart 800 showing various stages of an audience comment 124. In step 810, an audience member may post a comment to an event. The comment may be visible in the forum panel 120 by other audience members who have chosen to listen to the audience member posting the comment, for example, by selecting listen button 152. Those audience members who are able to view the comment may rate the comment using rating buttons 156. When other audience members rate the comment, the rating of both the comment and the commenter may change.

In step 820, the comment may reach the public forum. A comment may reach the public forum if the rating of the particular comment exceeds a certain threshold for the event or the rating of the commenter is sufficiently high. The ratings of the comment and commenter may be combined to determine whether the comment is visible in the public forum. It may be possible for a comment to go directly to step 620 if the rating of the commenter is sufficiently high. A commenter may receive a notification when a comment becomes viewable in the public forum. When a comment is visible in the public forum, any user, including hosts, may view the comment unless the commenter has been muted by the particular user. A comment that is viewable in the public forum may continue to be rated by users.

In step 830, a comment may be selected as the forum favorite 122. The comment with the most positive ratings may be selected as the forum favorite 122. In various alternative embodiments, negative ratings may also be considered when determining a forum favorite 122. A commenter may be informed when a comment becomes the forum favorite. The commenter's rating may also receive a bonus when a comment becomes a forum favorite 122. Accordingly, a commenter who posts the forum favorite 122 may be likely to have all comments visible in the public forum. A forum favorite 122 may be replaced whenever another comment becomes more highly rated.

In step 840, a comment may be spotlighted by a host and become a spotlighted comment 114. A host may spotlight any comment that is visible in the public forum. The spotlighted comment 114 may be visible in the host panel 110. The spotlighted comment 114 may also be visible as the most recent spotlighted comment 116 until a host spotlights another comment. When a comment is spotlighted by a host, the commenter may receive a notification. Spotlighting a comment may also provide a bonus to the rating of the comment and/or the commenter. The bonus may vary based on the number of users in the audience when the comment is spotlighted.

A commenter's rating, or Volume, may be an important factor in determining whether a comment is visible in the public forum. The Volume may be represented by a number and a level. The Volume number may be a score determined based on various statistics regarding the user's activity within the social networking platform. For example, the Volume number may be based on statistics including: the number of events attended, the number of events hosted, the number of other users who listen to the user, the number of comments spotlighted, the size of the audience when a comment was spotlighted, the number of comments that were forum favorite, the number of net positive ratings, and the number of comments visible in the public forum. The various statistics may be combined to reflect the popularity of the user. For example, the statistics may be combined using a weighted average to obtain the Volume number. The volume number may be calculated periodically, for example, once a day.

The Volume may have a relative level based on a percentile of the Volume number in comparison to other users. The Volume level may be determined for each event. Accordingly, a user may have a lower Volume level in a popular and crowded event, but have a greater Volume level in a less crowded event.

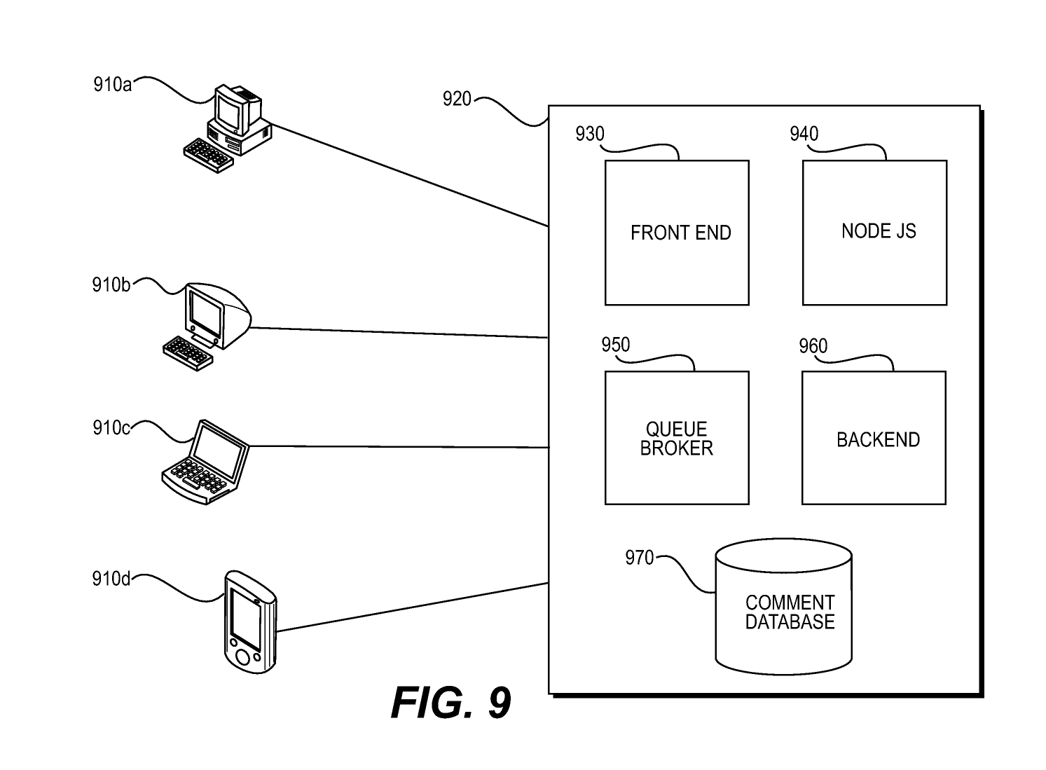

FIG. 9 illustrates an exemplary network 900 for implementing a social networking platform. Exemplary network 900 may include a plurality of user devices 910 in communication with a server 920.

User devices 910 may be any device capable of sending and receiving messages with server 920. User devices 910 may include personal computers, laptop computers, tablet computers, smart phones, personal digital assistants (PDA), and any other device capable of displaying a user interface and receiving input. In various embodiments, a user device 910 includes a browser application for displaying a website. The user device 910 may communicate with server 920 using the hypertext transfer protocol (HTTP). The browser may be a known browser application executing hypetext markup language (HTML) and/or javascript provided by server 920. In various embodiments, a user device 910 may run a customized application configured to display a user interface and receive input from a user. The application may also use HTTP or other known communication protocols.

Server 920 may be a web server configured to host a social network platform. Accordingly, server 920 may include a processor operably connected to a memory including instructions executable by the processor. In various embodiments, server 920 may be a cloud service. Accordingly, server 920 may be distributed across multiple physical servers, each having a processor and memory. Server 920 may include a front end module 930, a node JS module 940, a queue broker module 950, a backend module 960, and a comment database 970.

Front end module 930 may include computer software configured to present a user interface to a plurality of user devices 910. In various embodiments, front end module 930 may include HTML and javascript configured to present any of the user interfaces shown in FIGS. 1-7. The front end module 930 may serve the HTML and javascript to the user devices 910 when requested by a browser application.

Node JS module 940 may include computer software configured to manage connections between user devices 910 and server 920. Node JS module 940 may require each user of user devices 910 to login using a username and password. Upon login, Node JS module 940 may establish a websocket with the user device 910. The websocket may allow the Node JS 940 module to receive and push messages to the user devices 910. In various embodiments, the messages may be javascript object notation (JSON) messages following a JSON schema that may be understood by both server 920 and user devices 910. The JSON schema may define various types of messages used in the social network platform including comment messages, notifications, and user commands.

The queue broker 950 may include computer software configured to manage a plurality of message queues. The queue broker 950 may provide the contents of the queues to the node JS module 940 and the backend module 960. In various embodiments, queue broker 950 may include a queue for each user device 910, a host comment queue, and a user comment queue. The queue for each user device 910 may be a queue of messages to provide to the user device such as host comments, overheard user comments, and notifications. The host comment queue may include comments received by the hosts of the event. The contents of the host comment queue may be provided to the queue for each user device signed up for the event and to the comment database 970. The user comment queue may include comments received from audience member user devices. The contents of the user comment queue may be provided to the backend module 960 for analysis of individual comments.

The backend module 960 may include computer software configured to analyze individual comments. The backend module 960 may score individual comments based on the user's Volume and comment ratings. The backend module 960 may determine whether individual comments are overheard within an event based on the score. The backend module may provide any overheard comments to the queue for each user device signed up for the event. The backend module may also provide the comment and score to the comment database 970.

The comment database 970 may include a machine readable storage medium configured to store information regarding comments. In various embodiments, the comment database 970 may include a cache of active comments. The cache may be distributed across multiple servers or server instances, allowing for greater scalability of the social network platform. The comment database 970 may include a tuple for each comment. The tuple may include information such as the comment content, timestamp, score, comment type, and flags. The comment type may include host comments, user comments, moderator comments, and host spotlight comments. Host comments may be comments made by a host of the event. User comments may be comments made by audience members of the event. Overheard comments may be user comments that have an overheard flag set. Moderator comments may be comments made by a moderator for the social network platform. Host spotlight comments may be comments made by an audience member that have been spotlighted by a host. Host spotlight comments may be a separate entry in the comment database 970 linked to the original user comment.

According to the foregoing, various exemplary embodiments provide for a social networking platform. In particular, by providing hosted events with a rating system for comments, the social networking platform may provide an effective platform for meaningful dialogue between participants.

It should be apparent from the foregoing description that various exemplary embodiments of the invention may be implemented in hardware, and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention.

We claim:

1. A method of providing an online hosted event having at least two hosts and a plurality of audience members within a social network, the method comprising:
receiving a host message from a host;
sending to the plurality of audience members an instruction to display the host message in a first panel;
receiving an audience member comment from a first audience member;
scoring the audience member comment based on a volume rating of the first audience member;
sending to the plurality of audience members an instruction to display the audience member comment in a second panel visible to each audience member based on the score;
receiving an indication that a host has selected the audience member comment; and
sending to the plurality of audience members an instruction to display the selected audience member comment in the first panel.

2. The method of claim 1, further comprising increasing the volume rating of the first audience member based on the selection by the host.

3. The method of claim 1, wherein the step of sending to the plurality of audience members an instruction to display the audience member comment comprises limiting the rate at which audience member comments are displayed; and selecting a highest scored comment to display when allowed by the rate.

4. The method of claim 1, further comprising determining whether a second audience member is able to see the audience member comment based on a setting for the first audience member; and sending an instruction to display the audience member comment on the second panel of the second audience member.

5. The method of claim 4, further comprising:
receiving comment ratings for the audience member comment;
adjusting the comment score based on the comment ratings; and
sending to the plurality of audience members an instruction to display the audience member comment in a second panel based on the adjusted score.

6. The method of claim 5, further comprising selecting an audience member comment having a highest comment rating and displaying the audience member comment having the highest comment rating within a fixed location of the second panel.

7. The method of claim 6, wherein the volume rating comprises a volume number and a volume level, the volume number based on activity of the audience member in relation to other events within the social network, and the volume level based on a comparison of the volume number with the volume number of the plurality of audience members of the event.

8. A method performed by a user device for hosting an online hosted event having at least two hosts and a plurality of audience members within a social network, the method comprising:
displaying an interface having a first panel and a second panel;
receiving input comments from the user;
displaying the input comments in the first panel;
receiving audience member comments;
displaying audience member comments in the second panel;
receiving a user selection of an audience member comment; and
displaying the selected audience member comment in the first panel.

9. The method of claim 8, wherein the score of the audience member comment is increased responsive to the user selection of the audience member comment.

10. The method of claim 8, further comprising determining whether to display an audience member comment based on a setting of the user for the audience member; and displaying the audience member comment on the second panel regardless of the comment score.

11. The method of claim 10, further comprising:
rating an audience member comment;
receiving an adjusted comment score for the audience member comment based on a plurality of comment ratings; and
displaying the audience member comment in the second panel based on the adjusted score.

12. The method of claim 11, further comprising receiving an indication of an audience member comment having a highest score and displaying the audience member comment having the highest score within a fixed location of the second panel.

13. The method of claim 12, wherein the comment score is based on a volume number, a volume level, and the plurality of comment ratings, the volume number based on activity of the audience member in relation to other events within the social network, and the volume level based on a comparison of the volume number with the volume number of other audience members of the event.

14. A method performed by a user device for participating in an online hosted event having at least two hosts and a plurality of audience members within a social network, the method comprising:
displaying an interface having a first panel and a second panel;
receiving host comments;
displaying the host comments in the first panel;
receiving audience member comments;
displaying audience member comments in the second panel;
receiving an indication that a host has selected an audience member message; and
displaying the selected audience member comment in the first panel.

15. The method of claim 14, further comprising:
receiving a user selection to listen to another audience member; and
displaying any comment from the another audience member in the second panel.

16. The method of claim 14, further comprising:
receiving a notification indicating that a comment of the user has been selected as one of a host spotlighted comment and a forum favorite comment; and
displaying the notification to the user.

17. The method of claim 14, wherein the score of the audience member comment is increased responsive to the host selection of the audience member comment.

18. The method of claim 14, further comprising:
rating an audience member comment;
receiving an adjusted comment score for the audience member comment based on a plurality of comment ratings; and
displaying the audience member comment in the second panel based on the adjusted score.

19. The method of claim 18, further comprising receiving an indication of an audience member comment having a highest score and displaying the audience member comment having the highest score within a fixed location of the second panel.

20. The method of claim 18, wherein the comment score is based on a volume number, a volume level, and the plurality of comment ratings, the volume number based on activity of the audience member in relation to other events within the social network, and the volume level based on a comparison of the volume number with the volume number of other audience members of the event.

21. A computer server for providing an online event for a plurality of users including two hosts and a plurality of audience members, the server comprising:
a front end module configured to provide an interface to a user device of each user;
a node module configured to establish a connection with each user device, the connection allowing the server to push comments to each user device;
a queue broker configured to establish a queue of comments for each of the users, a host comment queue, and an audience member comment queue;
a comment database configured to store each comment received from the users, each comment including a comment type; and
a backend module configured to receive comments from the queue broker, select users to receive each comment based on the comment type, and add the comments to the queues of the selected users.

22. The server of claim 22, wherein the backend module is further configured to:
periodically determine a volume score for each audience member;
receive a comment from the audience member comment queue;
determine a comment score for the comment based on the volume score;
determine whether the comment score exceeds a threshold score based on the volume score of other audience members;
add the comment to the queues of each user responsive to the comment score exceeding the threshold score; and
add the comment to the queue of each user who has elected to listen to the audience member.

23. The server of claim 22, wherein the backend module is further configured to:
receive an indication that an audience member comment has been spotlighted by a host;
increase the volume score of the audience member based on the indication;
add a new spotlighted comment to the comment database; and
add the spotlighted comment to the queue for each user.
